(19) United States
(12) Patent Application Publication
(10) Pub. No.: US 2024/0068213 A1
(43) Pub. Date: Feb. 29, 2024

(54) Remote-Controlled Adjustable Showerhead Device

(71) Applicants: James Bevard, JR., Mount Vernon, OH (US); Lillian Bevard, Mount Vernon, OH (US)

(72) Inventors: James Bevard, JR., Mount Vernon, OH (US); Lillian Bevard, Mount Vernon, OH (US)

(21) Appl. No.: 18/186,314

(22) Filed: Mar. 20, 2023

Related U.S. Application Data
(60) Provisional application No. 63/402,675, filed on Aug. 31, 2022.

(51) Int. Cl. E03C 1/05; B05B 15/68; E03C 1/04

(52) U.S. Cl. CPC E03C 1/055; B05B 15/68; E03C 1/0408; E03C 2001/026

(57) ABSTRACT

The present invention relates to a remote-controlled adjustable showerhead device that allows a user to adjust the position and water pressure of the showerhead without having to physically touch the showerhead. The motor of the showerhead allows the showerhead to move 360 degrees during use, wherein the limiter allows a user to restrict the flow of water through the showerhead to adjust the water pressure. The limiter and motor can be controlled via the remote, which is preferably waterproof and can be stored within a shower. The motor and limiter are powered by a battery that can be housed within/on the showerhead or outside of the shower.

### CROSS-REFERENCE TO RELATED APPLICATION

The present application claims priority to, and the benefit of, U.S. Provisional Application No. 63/402,675, which was filed on Aug. 31, 2022, and is incorporated herein by reference in its entirety.

### FIELD OF THE INVENTION

The present invention relates generally to the field of showerheads. More specifically, the present invention relates to a remote-controlled adjustable showerhead device that allows a user to adjust the position and water pressure of the showerhead without having the physically touch the showerhead. Accordingly, the present disclosure makes specific reference thereto. Nonetheless, it is to be appreciated that aspects of the present invention are also equally applicable to other like applications, devices, and methods of manufacture.

### BACKGROUND

Many individuals may have difficulty reaching a showerhead. This can be due to a physical disability, lack of mobility, old age, height, etc. As a result, it may be physically impossible for some individuals to change the stream direction and pressure settings of a showerhead. This can result in frustration and a loss of independence. This is especially true for a private task like taking a shower. In addition, when an individual who cannot physically reach a showerhead attempts to do so, a slip and fall may occur that can end in serious injury or death.

Therefore, there exists a long-felt need in the art for an improved showerhead. There also exists a long-felt need in the art for a remote-controlled adjustable showerhead device. More specifically, there exists a long-felt need in the art for a remote-controlled adjustable showerhead device that allows a user to change the position of a showerhead without having to physically touch the showerhead. In addition, there exists a long-felt need in the art for a remote-controlled adjustable showerhead device that allows a user to change the water pressure of a showerhead without having to physically touch the showerhead.

The subject matter disclosed and claimed herein, in one embodiment thereof, comprises a remote-controlled adjustable showerhead device. The device is primarily comprised of a showerhead comprised of at least one motor, at least one limiter, at least one remote, and at least one battery. The motor of the showerhead allows the showerhead to move 360 degrees during use. The limiter allows a user to restrict the flow of water through the showerhead to adjust the water pressure. The limiter and motor can be controlled via the remote, which is preferably waterproof and can be stored within a shower. The motor and limiter are powered by a battery that can be housed within/on the showerhead or outside of the shower.

In this manner, the remote-controlled adjustable showerhead device of the present invention accomplishes all the foregoing objectives and provides an improved showerhead. To provide said improved showerhead, the device allows a user to change the position of a showerhead without having to physically touch the showerhead. In addition, the device allows a user to change the water pressure of a showerhead without having to physically touch the showerhead.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a remote-controlled adjustable showerhead device. The device is primarily comprised of a showerhead having at least one motor, at least one limiter, at least one remote, and at least one battery. The showerhead body has at least one pivot point. The pivot point is preferably a water-tight joint that allows the showerhead to move 360 degrees relative to a water pipe the showerhead is attached to. The pivot point may be a ball and socket joint, or other showerhead pivot point known in the art that is watertight and allows the showerhead to rotate 360 degrees during use.

The position of the showerhead can be manipulated using at least one remote that controls a motor. The body is also comprised of at least one motorized limiter that can contract or expand within the body. As a result, the contraction or expansion allows a user to increase or decrease the water pressure of water exiting the body by limiting or increasing the flow of water into/from the showerhead from a water pipe due to the limiter. In this manner, a user can adjust the water pressure as desired while showering.

Both the motor and limiter are powered by at least one battery. In one embodiment, the battery is comprised of a rechargeable battery that is removable from the body. In another embodiment, the battery is located outside of a shower. In this embodiment, the battery is in wired electrical communication with the motor and limiter via at least one wire that travels into a shower to the showerhead.

The movement of the motor and the expansion and contraction of the limiter is controlled by at least one remote. The remote is preferably waterproof such that it can be stored within a shower and may be comprised of at least one fastener that allows the remote to be secured to a shower wall. The remote is in wireless electrical communication with at least one receiver of the showerhead via at least one transmitter.

The present invention is also comprised of a method of use. First, a remote-controlled adjustable showerhead device is provided, the device is primarily comprised of a showerhead having a body, a water opening, a motor, a limiter, a receiver, a battery, and a remote having a transmitter. Then, the showerhead is attached to a water pipe of a shower via a connection opening and a fastener. Next, water is supplied to the showerhead. Then, the user can use the remote to adjust the position of the showerhead via the motor and also adjust the water pressure of the showerhead via the limiter.

Accordingly, the remote-controlled adjustable showerhead device of the present invention is particularly advantageous as it provides an improved showerhead. The device allows a user to change the position of a showerhead without having to physically touch the showerhead. In addition, the device allows a user to change the water pressure of a showerhead without having to physically touch the showerhead. In this manner, the remote-controlled adjustable showerhead device overcomes the limitations of existing showerheads known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a showerhead of one potential embodiment of a remote-controlled adjustable showerhead device of the present invention in accordance with the disclosed architecture;

FIG. 2 illustrates a perspective view of a remote of one potential embodiment of a remote-controlled adjustable showerhead device of the present invention in accordance with the disclosed architecture;

FIG. 3 illustrates a front-facing perspective view of a showerhead of one potential embodiment of a remote-controlled adjustable showerhead device of the present invention installed within a bathroom in accordance with the disclosed architecture; and

FIG. 4 illustrates a flowchart of a method of using one potential embodiment of a remote-controlled adjustable showerhead device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved showerhead. There also exists a long-felt need in the art for a remote-controlled adjustable showerhead device. More specifically, there exists a long-felt need in the art for a remote-controlled adjustable showerhead device that allows a user to change the position of a showerhead without having to physically touch the showerhead. In addition, there exists a long-felt need in the art for a remote-controlled adjustable showerhead device that allows a user to change the water pressure of a showerhead without having to physically touch the showerhead.

The present invention, in one exemplary embodiment, is comprised of a remote-controlled adjustable showerhead device primarily comprised of a showerhead having at least one motor, at least one limiter, at least one remote, and at least one battery. The showerhead body has at least one pivot point. The pivot point is preferably a water-tight joint that allows the showerhead to move 360 degrees relative to a water pipe the showerhead is attached to. The pivot point may be a ball and socket joint, or other showerhead pivot point known in the art that is watertight and allows the showerhead to rotate 360 degrees during use.

The position of the showerhead can be manipulated using at least one remote that controls a motor. The body is also comprised of at least one motorized limiter that can contract or expand within the body. As a result, the contraction or expansion allows a user to increase or decrease the water pressure of water exiting the body by limiting or increasing the flow of water into/from the showerhead from a water pipe due to the limiter. In this manner, a user can adjust the water pressure as desired while showering.

Both the motor and limiter are powered by at least one battery. The battery may be a rechargeable battery that is removable from the body. In another embodiment, the battery is located outside of a shower. In this embodiment, the battery is in wired electrical communication with the motor and limiter via at least one wire that travels into a shower to the showerhead.

The movement of the motor and the expansion and contraction of the limiter is controlled by at least one remote. The remote is preferably waterproof such that it can be stored in a shower. The remote may be comprised of at least one fastener that allows the remote to be secured to a shower wall. The remote is in wireless electrical communication with at least one receiver of the showerhead via at least one transmitter.

The present invention is also comprised of a method of use. First, a remote-controlled adjustable showerhead device is provided, the device is primarily comprised of a showerhead having a body, a water opening, a motor, a limiter, a receiver, a battery, and a remote having a transmitter. Then, the showerhead is attached to a water pipe of a shower via a connection opening and a fastener. Next, water is supplied to the showerhead. Then, the user can use the remote to adjust the position of the showerhead via the motor and also adjust the water pressure of the showerhead via the limiter.

Accordingly, the remote-controlled adjustable showerhead device of the present invention is particularly advantageous as it provides an improved showerhead. The device allows a user to change the position of a showerhead without having to physically touch the showerhead. In addition, the device allows a user to change the water pressure of a showerhead without having to physically touch the showerhead. In this manner, the remote-controlled adjustable showerhead device overcomes the limitations of existing showerheads known in the art.

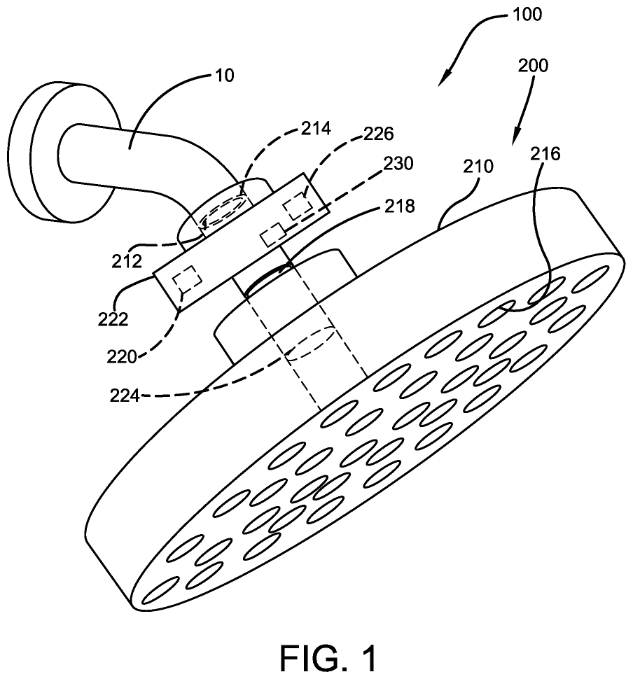

Referring initially to the drawings, FIG. 1 illustrates a perspective view of a showerhead 200 of one potential embodiment of a remote-controlled adjustable showerhead device 100 of the present invention in accordance with the disclosed architecture. The device 100 is primarily comprised of a showerhead 200 having at least one motor 220, at least one limiter 222, at least one remote 240, and at least one battery 230. The showerhead 200 has a body 210 that may be any style, shape, configuration, fit, and finish of showerhead 200 known in the art. The showerhead 200 is preferably hollow or partially hollow to allow water to flow through the showerhead 200.

The body 210 is comprised of a connection opening 212 that allows the showerhead 200 to attach to a water pipe 10 of a bathroom. In the preferred embodiment, the opening 212 is comprised of at least one fastener 214 that allows the showerhead 200 to attach to the water pipe 10. The fastener 214 is preferably a plurality of male or female threads but may be any fastener type known in the art of attaching showerheads 200 to a water pipe 10.

The showerhead 200 also has at least one water opening 216. The water opening 216 allows water to exit the body 210 of the showerhead 200 during use. In the preferred embodiment the body 210 has a plurality of openings 216. The openings 216 may be any size and shape, and may be arranged in any pattern, orientation, etc., known in the art of showerheads.

The body 210 also has at least one pivot point 218. The pivot point is preferably a water-tight joint that allows the showerhead 200 to move 360 degrees relative to a water pipe 10 it is attached to. In one embodiment, the pivot point 218 may be positioned within the body 210. The pivot point 218 may be a ball and socket joint, or other showerhead pivot point 218 known in the art that is watertight and allows the showerhead 200 to rotate 360 degrees during use.

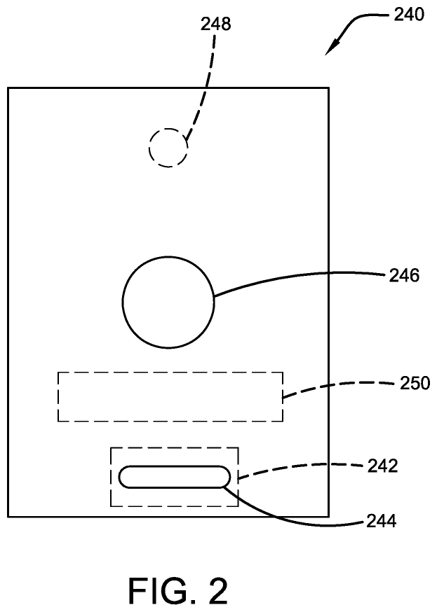

The position of the showerhead 200 can be manipulated using at least one remote 240 (as seen in FIG. 2) that controls at least one motor 220. The motor 220 may be positioned internally or externally on the body 210. If externally positioned, the motor 220 may be comprised of an exterior housing 222 that is waterproof. The motor 220 may also be waterproof if placed internally within the body 210.

The body 210 is also comprised of at least one motorized limiter 224. The limiter 224 is preferably motorized such that it can contract or expand within the body 210. As a result, the contraction or expansion allows a user to increase or decrease the water pressure of water exiting the body 210 by limiting or increasing the flow of water into/from the showerhead 200 from a water pipe 10 due to the limiter 224. In this manner, a user can adjust the water pressure as desired while showering. In one embodiment, the limiter 224 can fully block the flow of water from the showerhead 200 to allow a user to momentarily block the flow of water from the showerhead 200.

Both the motor 220 and limiter 224 are powered by at least one battery 230. In one embodiment, the battery 230 is comprised of a rechargeable battery 230 that is removable from the body 210 and is in electrical communication with both the motor 220 and limiter 224. In this embodiment, the battery 230 is comprised of a waterproof housing 232.

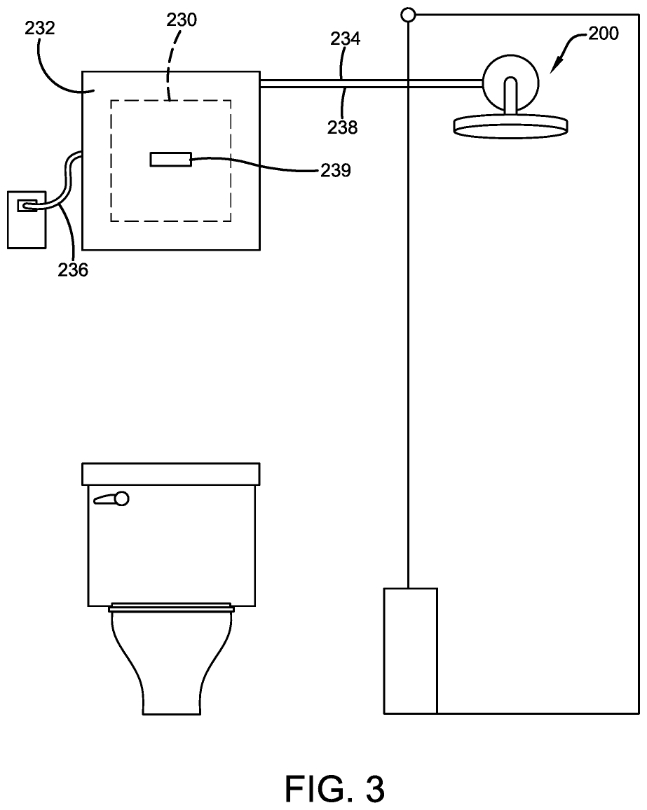

In another embodiment, the battery 230 is located outside of a shower, as seen in FIG. 3. In this embodiment the battery 230 is in wired electrical communication with the motor 220 and limiter 224 via at least one wire 234 that travels into a shower to the showerhead 200. The wire 234 is preferably comprised of a waterproof outer surface 238. In this embodiment, the housing 232 of the battery 230 can be mounted to a wall or other surface, wherein the battery 230 is removable from the housing 232. The battery 230 can be recharged via at least one charging port 239 such as, but not limited to, a USB port. In another embodiment, the battery 230 receives constant power outside of a shower via at least one power cord 236. In this embodiment, the power cord 236 is comprised of a 110 v/220 v power cord.

The movement of the motor 220 and the expansion and contraction of the limiter 224 is controlled by at least one remote 240. The remote 240 is preferably waterproof such that it can be stored in a shower. The remote 240 may be comprised of at least one fastener 250 such as, but not limited to, a suction cup that allows the remote 240 to be secured to a shower wall. The remote 240 is in wireless electrical communication with at least one receiver 226 of the showerhead 200 via at least one transmitter 248. The transmitter 248 may communicate with the receiver 226 via Bluetooth, RFID, etc.

The remote 240 is comprised of a battery 244. The battery 244 may be a removable battery or a rechargeable battery. A rechargeable battery embodiment can be recharged via at least one charging port 242 such as, but not limited to, a USB port.

The remote 240 is comprised of at least one button 246. In one embodiment, a first button 246 allows a user to control the functions of the motor 220 and limiter 224. More specifically, the button 246 allows a user to control the motor 220 to move the body 210 of the showerhead 200 360 degrees. This allows a user to easily reposition the showerhead 200 without physically touching the showerhead 200. A second button 246 may also allow a user to control the expansion and contraction of the limiter 224 to control the pressure of the water exiting the showerhead 200 for user comfort.

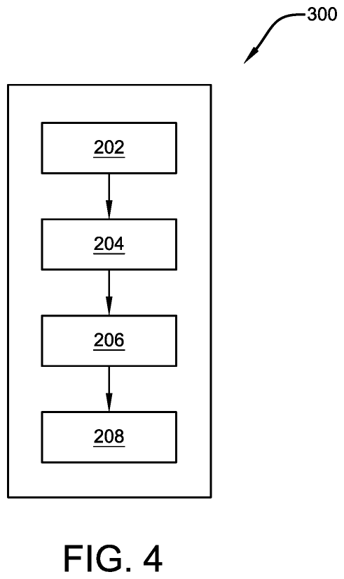

The present invention is also comprised of a method of use 300, as seen in FIG. 4. First, a remote-controlled adjustable showerhead device 100 is provided, the device 100 is primarily comprised of a showerhead 200 having a body 210, a water opening 216, a motor 220, a limiter 224, a receiver 226, a battery 230, and a remote 240 having a transmitter 248 [Step 302]. Then, the showerhead 200 is attached to a water pipe 10 of a shower via a connection opening 214 and a fastener 214 [Step 304]. Next, water is supplied to the showerhead 200 [Step 306]. Then, the user can use the remote 240 to adjust the position of the showerhead 200 via the motor 220 and also adjust the water pressure of the showerhead 200 via the limiter 224 [Step 308].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “remote-controlled adjustable showerhead device” and “device” are interchangeable and refer to the remote-controlled adjustable showerhead device 100 of the present invention.

Notwithstanding the foregoing, the remote-controlled adjustable showerhead device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the remote-controlled adjustable showerhead device 100 as shown in the FIGS. are for illustrative purposes only, and that many other sizes and shapes of the remote-controlled adjustable showerhead device 100 are well within the scope of the present disclosure. Although the dimensions of the remote-controlled adjustable showerhead device 100 are important design parameters for user convenience, the remote-controlled adjustable showerhead device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A remote-controlled adjustable showerhead device comprising:
a showerhead comprised of a body, a connection opening, a fastener, a water opening, and a pivot point;
a motor;
a limiter;
a receiver;
a remote comprised of a button and a transmitter; and
a battery.

2. The remote-controlled adjustable showerhead device of claim 1, wherein the pivot point is comprised of a ball and socket joint.

3. The remote-controlled adjustable showerhead device of claim 1, wherein the motor is powered by the battery.

4. The remote-controlled adjustable showerhead device of claim 1, wherein the limiter is powered by the battery.

5. The remote-controlled adjustable showerhead device of claim 1, wherein the motor is attached to the pivot point.

6. The remote-controlled adjustable showerhead device of claim 1, wherein the showerhead can rotate 360 degrees around the pivot point.

7. The remote-controlled adjustable showerhead device of claim 1, wherein the limiter can expand and contract via the motor.

8. The remote-controlled adjustable showerhead device of claim 1, wherein the battery is positioned within the body.

9. A remote-controlled adjustable showerhead device comprising:
a showerhead comprised of a body, a connection opening, a fastener, a water opening, a pivot point, a motor, a receiver, and a limiter;
a remote comprised of a button and a transmitter; and
a battery comprised of a housing.

10. The remote-controlled adjustable showerhead device of claim 9, wherein the remote is comprised of a fastener.

11. The remote-controlled adjustable showerhead device of claim 10, wherein the fastener is comprised of a suction cup.

12. The remote-controlled adjustable showerhead device of claim 9, wherein the housing is comprised of a waterproof housing.

13. The remote-controlled adjustable showerhead device of claim 9, wherein the battery is comprised of a charging port.

14. The remote-controlled adjustable showerhead device of claim 9, wherein the battery is in electrical communication with the motor via a wire.

15. The remote-controlled adjustable showerhead device of claim 14, wherein the wire is comprised of a waterproof outer surface.

16. The remote-controlled adjustable showerhead device of claim 9, wherein the transmitter is in wireless electrical communication with the receiver.

17. The remote-controlled adjustable showerhead device of claim 9, wherein the limiter can expand and contract via the motor.

18. The remote-controlled adjustable showerhead device of claim 9, wherein the housing is positioned outside the battery.

19. The remote-controlled adjustable showerhead device of claim 9, wherein the remote is comprised of a waterproof remote.

20. A method of using a remote-controlled adjustable showerhead device, the method comprising the steps of:
providing a remote-controlled adjustable showerhead device comprised of a battery, a remote comprised of a transmitter, and a showerhead comprised of a water opening, a motor, a limiter, and a receiver;
attaching the showerhead to a water pipe;
supplying an amount of water to the showerhead;
using the remote to adjust the position of the showerhead via the motor; and
using the remote to adjust a water pressure of the water exiting the showerhead via the water opening.
